(19) United States
(12) Patent Application Publication
(10) Pub. No.: US 2025/0252152 A1
(43) Pub. Date: Aug. 7, 2025

(54) RISK ASSESSMENT AND CONTROL METHOD FOR RADIAL CRACKING AND CRACK PROPAGATION AND TRANSFIXION OF CEMENT SHEATH IN FRACTURING WELLS

(71) Applicant: Chongqing University of Science & Technology, Chongqing (CN)

(72) Inventors: Honglin XU, Chongqing (CN); Lei ZHOU, Chongqing (CN); Pei HE, Chongqing (CN); Zheming ZHU, Chongqing (CN); Bin YANG, Chongqing (CN); Nian PENG, Chongqing (CN); Shilin XIANG, Chongqing (CN); Ce ZHANG, Chongqing (CN); Jie WEN, Chongqing (CN)

(73) Assignee: Chongqing University of Science & Technology, Chongqing (CN)

(21) Appl. No.: 18/945,595

(22) Filed: Nov. 13, 2024

(30) Foreign Application Priority Data
Feb. 2, 2024 (CN) 202410149195.X

(51) Int. Cl. G06F 17/12; E21B 43/26

(52) U.S. Cl. CPC G06F 17/12; E21B 43/26

(57) ABSTRACT

A risk assessment and control method for radial cracking and crack propagation and transfixion of cement sheath in fracturing wells is provided. Based on the thermo-solid coupling theoretical model of casing-cement sheath-formation combination and thick-walled cylinder theory, the tangential stress distribution of crack-free cement sheath when fracturing is obtained, the maximum tensile stress criterion is used to judge whether the cement sheath has radial initial cracking when fracturing and calculate the initial cracking length, based on the weight function method, the stress intensity factor of the tip of the radial initial cracking of the cement sheath when fracturing is calculated, the fracture mechanics criterion is used to judge whether the radial crack propagation and transfixion will occur in the cement sheath, and the performance parameters of the cement sheath are controlled by the double standards of preventing the radial cracking of the cement sheath and controlling the crack propagation.

### CROSS REFERENCE TO THE RELATED APPLICATIONS

This application is based upon and claims priority to Chinese Patent Application No. 202410149195.X, filed on Feb. 2, 2024, the entire contents of which are incorporated herein by reference.

### TECHNICAL FIELD

The invention relates to the field of wellbore integrity and safety technology of oil and gas wells, and in particular, relates to a risk assessment and control method for radial cracking and crack propagation and transfixion of cement sheath in fracturing wells.

### BACKGROUND

Fracturing is a key technical means for the efficient exploitation of unconventional oil and gas resources such as shale gas and tight gas, however, the high internal pressure and large temperature drop suffered by the wellbore when fracturing construction can easily lead to the sealing failure of the cement sheath, among them, the radial cracking of the cement sheath under the action of tangential tensile stress is one of the main forms of cement sheath failure in fracturing wells. The radial cracking and crack propagation and transfixion of cement sheath mean that the structural integrity of the cement sheath is lost, which is easy to induce gas leakage and annulus pressure, which poses a great threat to the safe production of gas wells. Therefore, rapid, economical, and reliable evaluation and efficient regulation of the risk of radial cracking and crack propagation and transfixion of cement sheath in fracturing wells are very important for the safety management of gas wells.

The existing risk assessment methods for radial cracking of cement sheath mainly include the theoretical method, finite element method, and indoor experiment method. At present, the theoretical method and the finite element method mainly judge whether the cement sheath produces radial cracking by obtaining the tangential stress distribution of the cement sheath and using the static mechanical criterion, which cannot reliably evaluate the risk of dynamic growth, propagation and transfixion of the radial crack of the cement sheath. Although the indoor experiment method can simulate and test whether the cement sheath has radial cracking and penetration under fracturing construction conditions by establishing a full-size or small-size casing-cement sheath-formation combination physical model and combining CT scanning and other technical means, this method is costly, time-consuming, and laborious, and has certain safety risks. Generally, only a small number of confirmatory experiments are carried out.

Therefore, it is difficult to achieve rapid economic evaluation and efficient control of the risk of radial cracking and crack propagation and transfixion of cement sheath in fracturing wells by indoor experimental method.

### SUMMARY

The purpose of the invention is to provide a risk assessment and control method for radial cracking and crack propagation and transfixion of cement sheath in fracturing wells, and to solve the problem that it is difficult to achieve rapid economic evaluation and efficient control of radial cracking and crack propagation and transfixion of cement sheath in fracturing wells by indoor experimental method.

In order to achieve the above purpose, the invention provides a risk evaluation and control method for radial cracking and crack propagation and transfixion of cement sheath in fracturing wells, which includes the following steps:
S1, obtaining a pressure p_{c1} on a cement sheath-casing interface and a pressure p_{c2} on a cement sheath-formation interface when fracturing;
S2, obtaining a tangential stress distribution curve σ_{θ}(x) of a crack-free cement sheath when fracturing;
S3, judging whether a radial initial cracking of the cement sheath occurs when fracturing based on a maximum tensile stress criterion and calculating an initial cracking length a;
S4, when 0<a<t, calculating a stress intensity factor K_{I} (a) of a tip of the radial initial cracking of the cement sheath when fracturing based on a weight function method;
S5, comparing K_{I} (a) with a fracture toughness K_{Ic} of cement sheath, if K_{I}(a)≥K_{Ic}, it is judged that the cement sheath will undergo a radial crack propagation and transfixion.

S6, replacing a cement slurry system, improving a tensile strength σ_{ct} and the fracture toughness K_{Ic} of the cement sheath, and repeating S1-S5 until σ_{θ}(x)<0.90σ_{ct} or K_{I} (a)<0.9K_{Ic} is satisfied.

Where obtaining the pressure p_{c1} on the cement sheath-casing interface and the pressure p_{c2} on the cement sheath-formation interface when fracturing, the step also includes:

based on continuity conditions of a radial displacement of the cement sheath-casing interface and the cement sheath-formation interface, establishing a theoretical model of thermo-solid coupling of casing-cement sheath-formation combination, calculating the pressure p_{c1} on the cement sheath-casing interface and the pressure p_{c2} on the cement sheath-formation interface when fracturing by Formulas 1-2;

$${p}_{c 1} = \frac{\begin{matrix}[ {α}_{c} {E}_{c} {E}_{s} Δ T ( 1 + {v}_{c} ) - {α}_{s} {E}_{s} {E}_{c} Δ T ( 1 + {v}_{s} ) - \frac{2 {r}_{i}^{2}}{{r}_{1}^{2} - {r}_{i}^{2}} {E}_{c} ( 1 - {{v}_{s}}^{2} ) Δ {p}_{i} ] \times \\ [ {E}_{f} ( {v}_{c} + {{v}_{c}}^{2} ) - \frac{{r}_{2}^{2} + {r}_{1}^{2}}{{r}_{2}^{2} - {r}_{1}^{2}} {E}_{f} ( 1 - {{v}_{c}}^{2} ) - \frac{{r}_{o}^{2} + {r}_{2}^{2}}{{r}_{o}^{2} - {r}_{2}^{2}} {E}_{c} ( 1 - {{v}_{f}}^{2} ) - {E}_{c} ( {v}_{f} + {{v}_{f}}^{2} ) ] - \\ [ {α}_{f} {E}_{f} {E}_{c} Δ T ( 1 + {v}_{f} ) - {α}_{c} {E}_{c} {E}_{f} Δ T ( 1 + {v}_{c} ) ] \times [ \frac{2 {r}_{2}^{2}}{{r}_{2}^{2} - {r}_{1}^{2}} {E}_{s} ( 1 - {{v}_{c}}^{2} ) ]\end{matrix}}{\begin{matrix}[ {E}_{c} ( {v}_{s} + {{v}_{s}}^{2} ) - \frac{{r}_{1}^{2} + {r}_{i}^{2}}{{r}_{1}^{2} - {r}_{i}^{2}} {E}_{c} ( 1 - {{v}_{s}}^{2} ) - \frac{{r}_{2}^{2} + {r}_{1}^{2}}{{r}_{2}^{2} - {r}_{1}^{2}} {E}_{s} ( 1 - {{v}_{c}}^{2} ) - {E}_{s} ( {v}_{c} + {{v}_{c}}^{2} ) ] \times \\ [ {E}_{f} ( {v}_{c} + {{v}_{c}}^{2} ) - \frac{{r}_{2}^{2} + {r}_{1}^{2}}{{r}_{2}^{2} - {r}_{1}^{2}} {E}_{f} ( 1 - {{v}_{c}}^{2} ) - \frac{{r}_{o}^{2} + {r}_{2}^{2}}{{r}_{o}^{2} - {r}_{2}^{2}} {E}_{c} ( 1 - {{v}_{f}}^{2} ) - {E}_{c} ( {v}_{f} + {{v}_{f}}^{2} ) ] - \\ [ \frac{2 {r}_{1}^{2}}{{r}_{2}^{2} - {r}_{1}^{2}} {E}_{f} ( 1 - {{v}_{c}}^{2} ) ] \times [ \frac{2 {r}_{2}^{2}}{{r}_{2}^{2} - {r}_{1}^{2}} {E}_{s} ( 1 - {{v}_{c}}^{2} ) ]\end{matrix}} \qquad ( 1 )$$

$${p}_{c 2} = \frac{\begin{matrix}[ {α}_{c} {E}_{c} {E}_{s} Δ T ( 1 + {v}_{c} ) - {α}_{s} {E}_{s} {E}_{c} Δ T ( 1 + {v}_{s} ) - \\ \frac{2 {r}_{i}^{2}}{{r}_{1}^{2} - {r}_{i}^{2}} {E}_{c} ( 1 - {{v}_{s}}^{2} ) Δ {p}_{i} ] \times [ \frac{2 {r}_{1}^{2}}{{r}_{2}^{2} - {r}_{1}^{2}} {E}_{f} ( 1 - {v}_{c}^{2} ) ] - \\ [ {α}_{f} {E}_{f} {E}_{c} Δ T ( 1 + {v}_{f} ) - {α}_{c} {E}_{c} {E}_{f} Δ T ( 1 + {v}_{c} ) ] \times [ \begin{matrix}{E}_{c} ( {v}_{s} + {{v}_{s}}^{2} ) - \frac{{r}_{1}^{2} + {r}_{i}^{2}}{{r}_{1}^{2} - {r}_{i}^{2}} {E}_{c} ( 1 - {{v}_{s}}^{2} ) - \\ \frac{{r}_{2}^{2} + {r}_{1}^{2}}{{r}_{2}^{2} - {r}_{1}^{2}} {E}_{s} ( 1 - {{v}_{c}}^{2} ) - {E}_{s} ( {v}_{c} + {{v}_{c}}^{2} )\end{matrix} ]\end{matrix}}{\begin{matrix}[ \frac{2 {r}_{2}^{2}}{{r}_{2}^{2} - {r}_{1}^{2}} {E}_{s} ( 1 - {{v}_{c}}^{2} ) ] \times [ \frac{2 {r}_{1}^{2}}{{r}_{2}^{2} - {r}_{1}^{2}} {E}_{f} ( 1 - {{v}_{c}}^{2} ) ] - \\ [ {E}_{f} ( {v}_{c} + {{v}_{c}}^{2} ) - \frac{{r}_{2}^{2} + {r}_{1}^{2}}{{r}_{2}^{2} - {r}_{1}^{2}} {E}_{f} ( 1 - {{v}_{c}}^{2} ) - \frac{{r}_{o}^{2} + {r}_{2}^{2}}{{r}_{o}^{2} - {r}_{2}^{2}} {E}_{c} ( 1 - {{v}_{f}}^{2} ) - {E}_{c} ( {v}_{f} + {{v}_{f}}^{2} ) ] \times \\ [ {E}_{c} ( {v}_{s} + {{v}_{s}}^{2} ) - \frac{{r}_{1}^{2} + {r}_{i}^{2}}{{r}_{1}^{2} - {r}_{i}^{2}} {E}_{c} ( 1 - {{v}_{s}}^{2} ) - \frac{{r}_{2}^{2} + {r}_{1}^{2}}{{r}_{2}^{2} - {r}_{1}^{2}} {E}_{s} ( 1 - {{v}_{c}}^{2} ) - {E}_{s} ( {v}_{c} + {{v}_{c}}^{2} ) ]\end{matrix}} \qquad ( 2 )$$

in the formula: p_{c1} is a cement sheath-casing interface pressure, MPa; p_{c2} is a cement sheath-formation interface pressure, MPa; Δpᵢ is an increased inner casing pressure when fracturing, MPa; ΔT is a change value of wellbore temperature when fracturing, ° C.; rᵢ is an inner radius of the casing, mm; r₁ is an outer radius of the casing and inner radius of the cement sheath, mm; r₂ is an outer radius of cement sheath and inner radius of the formation, mm; rₒ is an outer radius of the formation, mm; Eₛ, E_{c}, E_{f} are elastic modulus of the casing, cement sheath and formation, MPa; vₛ, v_{c} and v_{f} are Poisson's ratios of the casing, cement sheath and formation, respectively, dimensionless. αₛ, α_{c}, and α_{f} are linear expansion coefficients of the casing, cement sheath, and formation, respectively, 1/° C.

Where obtaining the tangential stress distribution curve σ_{θ}(x) of the crack-free cement sheath when fracturing, the step also includes:

based on a thick-walled cylinder theory, calculating the tangential stress distribution of crack-free cement sheath when fracturing by Formula 3

$${σ}_{θ} ( x ) = \frac{{p}_{c 1} {r}_{1}^{2}}{{r}_{2}^{2} - {r}_{1}^{2}} [ 1 + \frac{{r}_{2}^{2}}{{( {r}_{1} + x )}^{2}} ] - \frac{{p}_{c 2} {r}_{2}^{2}}{{r}_{2}^{2} - {r}_{1}^{2}} [ 1 + \frac{{r}_{1}^{2}}{{( {r}_{1} + x )}^{2}} ] \qquad ( 3 )$$

$$( 0 \leq x \leq {r}_{2} - {r}_{1} )$$

in the formula: σ_{θ} is a tangential stress of the crack-free cement sheath when fracturing, MPa.

Where judging whether the radial initial cracking of the cement sheath occurs when fracturing based on the maximum tensile stress criterion and calculating the initial cracking length a, the step also includes:

drawing curves of σ_{θ} and σ_{ct} in a σ(x) coordinate system, and obtaining the radial initial cracking length a of cement sheath by Formula 4

$$a = \{ \begin{matrix}0 , & {σ}_{θ} ( x ) < {σ}_{ct} & No radial initial cracking in cement sheath \\ {r}_{b} - {r}_{1} , & {σ}_{θ} ( {r}_{b} ) = {σ}_{ct} & Radial initial cracking in a part of cement sheath \\ t , & {σ}_{θ} ( x ) > {σ}_{ct} & Radial initial cracking penetrates in cement sheath\end{matrix} \qquad ( 4 )$$

in the formula: a is the radial initial cracking length of the cement sheath, mm; t is a thickness of the cement sheath, mm; σ_{ct} is a tensile strength of the cement sheath, MPa; r_{b} is an abscissa corresponding to an intersection of σ_{θ} and σ_{ct} curves, mm.

when 0<a<t, calculating the stress intensity factor K_{I} (a) of the tip of the radial initial cracking of the cement sheath when fracturing based on the weight function method, the step also includes:

using Formulas 5-17 to calculate the stress intensity factor K_{I} (a) of the tip of the radial initial cracking of the cement sheath when fracturing;

$${K}_{I} ( a ) = \frac{{p}_{c 1} {r}_{1}^{2} - {p}_{c 2} {r}_{2}^{2}}{{r}_{2}^{2} - {r}_{1}^{2}} \frac{1}{\sqrt{2 π} F} \{ 4 F \sqrt{a} + \frac{2}{3} ( 4 \frac{dF}{da} + \frac{2 F}{a} + \frac{3 G}{2 a} ) {a}^{3 / 2} + \frac{2}{5 a} ( \frac{dG}{da} - \frac{G}{2 a} ) {a}^{5 / 2} \} + \frac{{r}_{1}^{2} {r}_{1}^{2} ( {p}_{c 1} - {p}_{c 2} )}{{r}_{2}^{2} - {r}_{1}^{2}} \frac{1}{\sqrt{2 π} F} \{ \begin{matrix}2 F [ \frac{\sqrt{a}}{{r}_{1} ( a + {r}_{1} )} + \frac{1}{2 {( a + {r}_{1} )}^{3 / 2}} ln ( \frac{\sqrt{a + {r}_{1}} + \sqrt{a}}{\sqrt{a + {r}_{1}} - \sqrt{a}} ) ] + \\ ( 4 \frac{dF}{da} + \frac{2 F}{a} + \frac{3 G}{2 a} ) [ \frac{\sqrt{a}}{{r}_{1}} - \frac{1}{2 \sqrt{a + {r}_{1}}} ln ( \frac{\sqrt{a + {r}_{1}} + \sqrt{a}}{\sqrt{a + {r}_{1}} - \sqrt{a}} ) ] + \\ \frac{1}{a} ( \frac{dG}{da} - \frac{G}{2 a} ) [ 3 \sqrt{a} - \frac{3}{2} \sqrt{a + {r}_{1}} ln ( \frac{\sqrt{a + {r}_{1}} + \sqrt{a}}{\sqrt{a + {r}_{1}} - \sqrt{a}} ) + \frac{{a}^{3 / 2}}{{r}_{1}} ]\end{matrix} \} \qquad ( 5 )$$

$$F = {A}_{1} + {A}_{2} {a}^{1 / 2} + {A}_{3} a \qquad ( 6 )$$

$${A}_{1} = \frac{w + 1}{2 \sqrt{π} {w}^{2}} {( w - 1 )}^{1 / 2} \times 5.714 \qquad ( 7 )$$

$${A}_{2} = - \frac{w + 1}{2 \sqrt{π} {w}^{2}} {t}^{- 1 / 2} \times 4.258 \qquad ( 8 )$$

$${A}_{3} = \frac{w + 1}{2 \sqrt{π} {w}^{2} {t ( w - 1 )}^{1 / 2}} \times 5.561 \qquad ( 9 )$$

$$w = {r}_{2} / {r}_{1} \qquad ( 10 )$$

$$G = ( {I}_{1} - 4 {FI}_{2} \sqrt{a} ) \sqrt{a} / {I}_{3} \qquad ( 11 )$$

$${I}_{1} = π \sqrt{2} \{ \frac{1}{2} {A}_{1}^{2} {a}^{2} + \frac{{A}_{2}^{2} + 2 {A}_{1} {A}_{3}}{3} {a}^{3} + \frac{1}{4} {A}_{3}^{2} {a}^{4} + \frac{4}{5} {A}_{1} {A}_{2} {a}^{5 / 2} + \frac{7}{4} {A}_{1} {A}_{3} {a}^{7 / 2} \} \qquad ( 12 )$$

$${I}_{2} = \frac{1}{2} \{ {r}_{1}^{2} [ \frac{\sqrt{a}}{{r}_{1}} - \frac{1}{2 \sqrt{a + {r}_{1}}} ln \frac{\sqrt{a + {r}_{1}} + \sqrt{a}}{\sqrt{a + {r}_{1}} - \sqrt{a}} ] + \frac{2}{3} {a}^{3 / 2} \} \qquad ( 13 )$$

$${I}_{3} = \frac{1}{2} \{ {r}_{1}^{2} [ 3 \sqrt{a} + \frac{a}{{r}_{1}} \sqrt{a} - \frac{3}{2} \sqrt{a + {r}_{1}} ln \frac{\sqrt{a + {r}_{1}} + \sqrt{a}}{\sqrt{a + {r}_{1}} - \sqrt{a}} ] + \frac{2}{5} {a}^{5 / 2} \} \qquad ( 14 )$$

$$\frac{dF}{da} = \frac{1}{2} \sqrt{\frac{{r}_{2} - {r}_{1}}{π}} \frac{{r}_{1} + {r}_{2}}{{r}_{2}^{2}} [ - 2.129 \frac{{r}_{1}}{\sqrt{a} ( {r}_{2} - {r}_{1} )} + 5.651 \frac{{r}_{1}^{3 / 2}}{{( {r}_{2} - {r}_{1} )}^{2}} ] \qquad ( 15 )$$

$$\frac{dG}{da} = \frac{1}{{I}_{3}} \{ \frac{( 2 \sqrt{2} π {F}^{2} {a}^{2} + {I}_{1} )}{2 \sqrt{a}} - 4 a ( \frac{dF}{da} {I}_{2} + F \frac{{dI}_{2}}{da} ) - ( 4 F + \frac{3}{2} G ) {I}_{2} \} \qquad ( 16 )$$

$$\frac{{dI}_{2}}{da} = \frac{1}{2} \{ {r}_{1}^{2} [ \frac{\sqrt{a}}{2 {r}_{1} ( a + {r}_{1} )} + \frac{1}{4 ( a + {r}_{1} ) \sqrt{a + {r}_{1}}} ln \frac{\sqrt{a + {r}_{1}} + \sqrt{a}}{\sqrt{a + {r}_{1}} - \sqrt{a}} ] + \sqrt{a} \} \qquad ( 17 )$$

in the formula, K_{I} is the stress intensity factor of the tip of the initial radial cracking of the cement sheath, N·mm^{-3/2}; A₁, A₂, A₃, F, G, I₁, I₂, I₃ are intermediate functions.

A risk assessment and control method for radial cracking and crack propagation and transfixion of cement sheath in fracturing wells is proposed, based on the thermo-solid coupling theoretical model of casing-cement sheath-formation combination and the thick-walled cylinder theory, the tangential stress distribution of crack-free cement sheath when fracturing is obtained, the maximum tensile stress criterion is used to judge whether the radial initial cracking of cement sheath occurs when fracturing and calculate the initial cracking length; based on the weight function method, the stress intensity factor of the tip of the radial initial cracking of the cement sheath when fracturing is calculated, the fracture mechanics criterion is used to judge whether the radial cracking and crack propagation and transfixion will occur in the cement sheath. The performance parameters of the cement sheath are controlled by the double standards of preventing the radial cracking of the cement sheath and controlling the crack propagation, the risk of radial cracking and crack propagation and transfixion of cement sheath in fracturing wells is rapidly evaluated and an effective control method is proposed. Compared with the existing theoretical method, finite element method, and indoor experimental method to evaluate the risk of radial cracking of cement sheath, this method can quickly evaluate the risk of radial cracking and crack propagation and transfixion of cement sheath in fracturing wellbore and provide an effective control method with high reliability.

### BRIEF DESCRIPTION OF THE DRAWINGS

In order to more clearly illustrate the technical solution in this application embodiment or existing technology, the following will briefly introduce the drawings that need to be used in the embodiment or existing technology description.

FIG. 1 is a tangential stress distribution map of the crack-free cement sheath when fracturing in the invention.

FIG. 2 is a schematic diagram for calculating the radial initial cracking length of the cement sheath in the invention.

FIG. 3 is a tangential stress distribution map of the crack-free cement sheath when fracturing after replacing the cement slurry system in the invention.

FIG. 4 is a schematic diagram for calculating the radial initial cracking length of the cement sheath after replacing the cement slurry system in the invention.

FIG. 5 is a flow chart of the risk assessment and control method for the radial cracking and crack propagation and transfixion of the cement sheath in the fracturing well in the invention.

### DETAILED DESCRIPTION OF THE EMBODIMENTS

The embodiment of the invention is described in detail below, and the examples of the embodiments are shown in the drawings, the embodiments described below by reference to the drawings are illustrative and are intended to be used to explain the invention, but cannot be understood as restrictions on the invention.

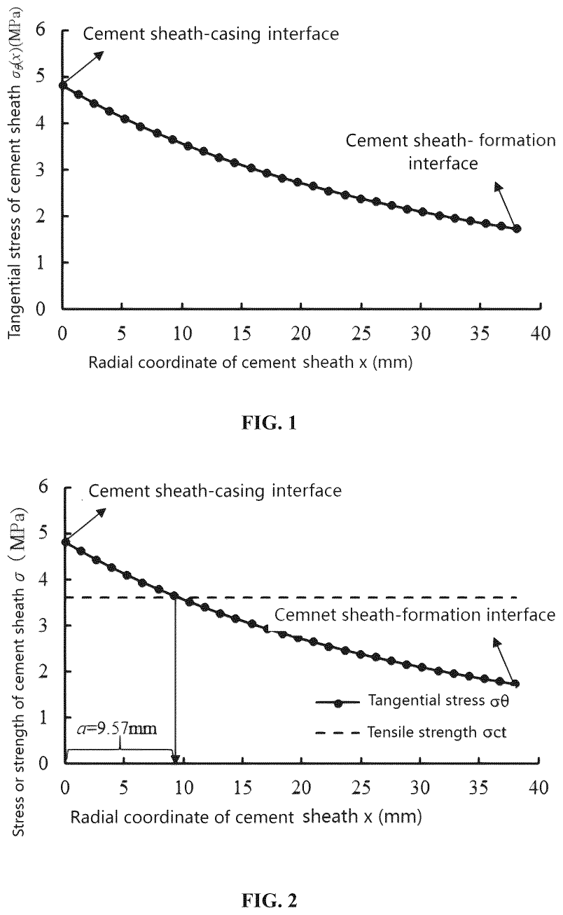

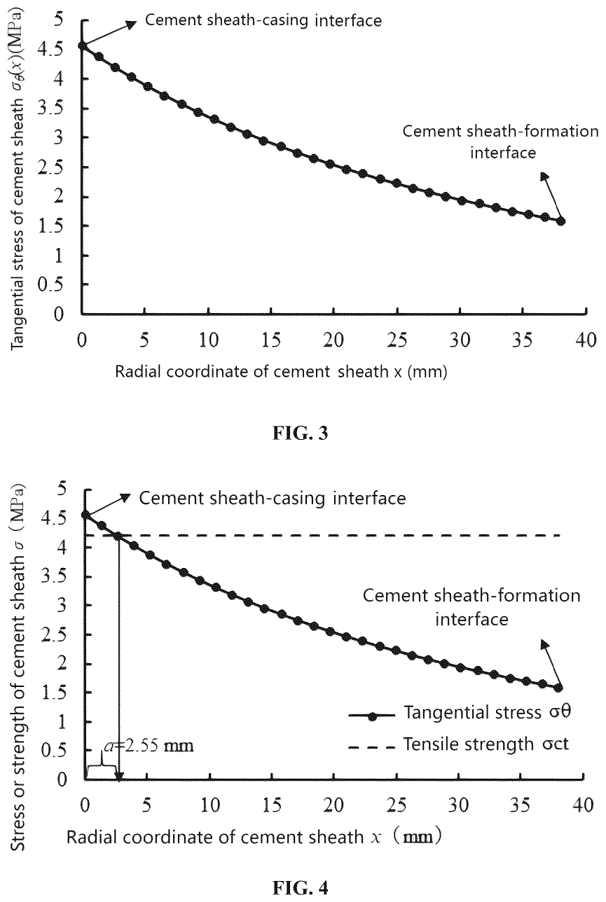

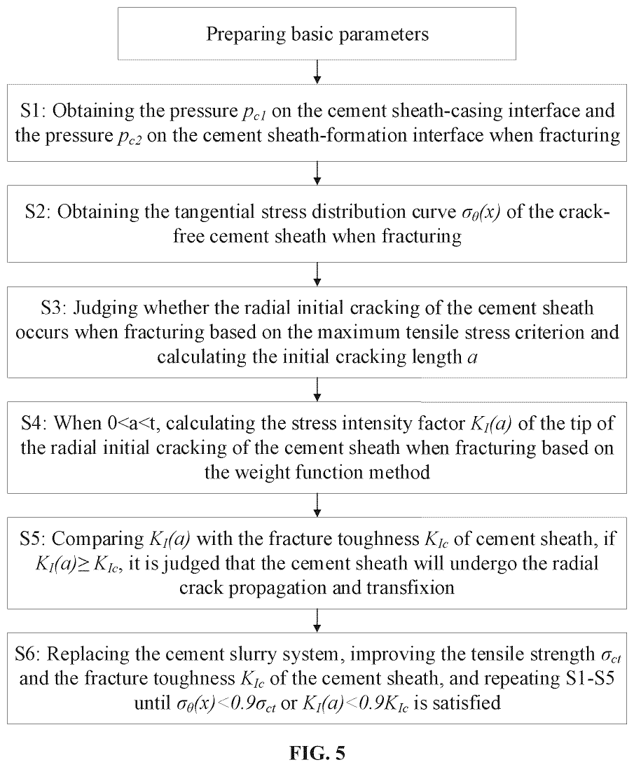

Please refer to FIGS. 1 to 5, where FIG. 1 is a tangential stress distribution map of the crack-free cement sheath when fracturing in the invention. FIG. 2 is a schematic diagram for calculating the radial initial cracking length of the cement sheath in the invention. FIG. 3 is a tangential stress distribution map of the crack-free cement sheath when fracturing after replacing the cement slurry system in the invention. FIG. 4 is a schematic diagram for calculating the radial initial cracking length of the cement sheath after replacing the cement slurry system in the invention. FIG. 5 is a flow chart of the risk assessment and control method for the radial cracking and crack propagation and transfixion of the cement sheath in the fracturing well in the invention. The invention provides a risk assessment and control method for radial cracking and crack propagation and transfixion of cement sheath in fracturing wells: including the following steps:

S1, the pressure p_{c1} on the cement sheath-casing interface and the pressure p_{c2} on the cement sheath-formation interface are obtained when fracturing;

Specifically, Δpᵢ, ΔT, rᵢ, r₁, r₂, rₒ, Eₛ, E_{c}, E_{f}, vₛ, v_{c}, v_{f}, αₛ, α_{c}, α_{f} are obtained, based on the continuity conditions of radial displacement of cement sheath-casing interface and cement sheath-formation interface, a theoretical model of thermo-solid coupling of casing-cement sheath-formation combination is established, the pressure p_{c1} on the cement sheath-casing interface and the pressure p_{c2} on the cement sheath-formation interface are calculated by Formula (1)-(2)

$${p}_{c 1} = \frac{\begin{matrix}[ {α}_{c} {E}_{c} {E}_{s} Δ T ( 1 + {v}_{c} ) - {α}_{s} {E}_{s} {E}_{c} Δ T ( 1 + {v}_{s} ) - \frac{2 {r}_{i}^{2}}{{r}_{1}^{2} - {r}_{i}^{2}} {E}_{c} ( 1 - {{v}_{s}}^{2} ) Δ {p}_{i} ] \times \\ [ {E}_{f} ( {v}_{c} + {{v}_{c}}^{2} ) - \frac{{r}_{2}^{2} + {r}_{1}^{2}}{{r}_{2}^{2} - {r}_{1}^{2}} {E}_{f} ( 1 - {{v}_{c}}^{2} ) - \frac{{r}_{o}^{2} + {r}_{2}^{2}}{{r}_{o}^{2} - {r}_{2}^{2}} {E}_{c} ( 1 - {{v}_{f}}^{2} ) - {E}_{c} ( {v}_{f} + {{v}_{f}}^{2} ) ] - \\ [ {α}_{f} {E}_{f} {E}_{c} Δ T ( 1 + {v}_{f} ) - {α}_{c} {E}_{c} {E}_{f} Δ T ( 1 + {v}_{c} ) ] \times [ \frac{2 {r}_{2}^{2}}{{r}_{2}^{2} - {r}_{1}^{2}} {E}_{s} ( 1 - {{v}_{c}}^{2} ) ]\end{matrix}}{\begin{matrix}[ {E}_{c} ( {v}_{s} + {{v}_{s}}^{2} ) - \frac{{r}_{1}^{2} + {r}_{i}^{2}}{{r}_{1}^{2} - {r}_{i}^{2}} {E}_{c} ( 1 - {{v}_{s}}^{2} ) - \frac{{r}_{2}^{2} + {r}_{1}^{2}}{{r}_{2}^{2} - {r}_{1}^{2}} {E}_{s} ( 1 - {{v}_{c}}^{2} ) - {E}_{s} ( {v}_{c} + {{v}_{c}}^{2} ) ] \times \\ [ {E}_{f} ( {v}_{c} + {{v}_{c}}^{2} ) - \frac{{r}_{2}^{2} + {r}_{1}^{2}}{{r}_{2}^{2} - {r}_{1}^{2}} {E}_{f} ( 1 - {{v}_{c}}^{2} ) - \frac{{r}_{o}^{2} + {r}_{2}^{2}}{{r}_{o}^{2} - {r}_{2}^{2}} {E}_{c} ( 1 - {{v}_{f}}^{2} ) - {E}_{c} ( {v}_{f} + {{v}_{f}}^{2} ) ] - \\ [ \frac{2 {r}_{1}^{2}}{{r}_{2}^{2} - {r}_{1}^{2}} {E}_{f} ( 1 - {{v}_{c}}^{2} ) ] \times [ \frac{2 {r}_{2}^{2}}{{r}_{2}^{2} - {r}_{1}^{2}} {E}_{s} ( 1 - {{v}_{c}}^{2} ) ]\end{matrix}} \qquad ( 1 )$$

$${p}_{c 2} = \frac{\begin{matrix}[ {α}_{c} {E}_{c} {E}_{s} Δ T ( 1 + {v}_{c} ) - {α}_{s} {E}_{s} {E}_{c} Δ T ( 1 + {v}_{s} ) - \\ \frac{2 {r}_{i}^{2}}{{r}_{1}^{2} - {r}_{i}^{2}} {E}_{c} ( 1 - {{v}_{s}}^{2} ) Δ {p}_{i} ] \times [ \frac{2 {r}_{1}^{2}}{{r}_{2}^{2} - {r}_{1}^{2}} {E}_{f} ( 1 - {v}_{c}^{2} ) ] - \\ [ {α}_{f} {E}_{f} {E}_{c} Δ T ( 1 + {v}_{f} ) - {α}_{c} {E}_{c} {E}_{f} Δ T ( 1 + {v}_{c} ) ] \times [ \begin{matrix}{E}_{c} ( {v}_{s} + {{v}_{s}}^{2} ) - \frac{{r}_{1}^{2} + {r}_{i}^{2}}{{r}_{1}^{2} - {r}_{i}^{2}} {E}_{c} ( 1 - {{v}_{s}}^{2} ) - \\ \frac{{r}_{2}^{2} + {r}_{1}^{2}}{{r}_{2}^{2} - {r}_{1}^{2}} {E}_{s} ( 1 - {{v}_{c}}^{2} ) - {E}_{s} ( {v}_{c} + {{v}_{c}}^{2} )\end{matrix} ]\end{matrix}}{\begin{matrix}[ \frac{2 {r}_{2}^{2}}{{r}_{2}^{2} - {r}_{1}^{2}} {E}_{s} ( 1 - {{v}_{c}}^{2} ) ] \times [ \frac{2 {r}_{1}^{2}}{{r}_{2}^{2} - {r}_{1}^{2}} {E}_{f} ( 1 - {{v}_{c}}^{2} ) ] - \\ [ {E}_{f} ( {v}_{c} + {{v}_{c}}^{2} ) - \frac{{r}_{2}^{2} + {r}_{1}^{2}}{{r}_{2}^{2} - {r}_{1}^{2}} {E}_{f} ( 1 - {{v}_{c}}^{2} ) - \frac{{r}_{o}^{2} + {r}_{2}^{2}}{{r}_{o}^{2} - {r}_{2}^{2}} {E}_{c} ( 1 - {{v}_{f}}^{2} ) - {E}_{c} ( {v}_{f} + {{v}_{f}}^{2} ) ] \times \\ [ {E}_{c} ( {v}_{s} + {{v}_{s}}^{2} ) - \frac{{r}_{1}^{2} + {r}_{i}^{2}}{{r}_{1}^{2} - {r}_{i}^{2}} {E}_{c} ( 1 - {{v}_{s}}^{2} ) - \frac{{r}_{2}^{2} + {r}_{1}^{2}}{{r}_{2}^{2} - {r}_{1}^{2}} {E}_{s} ( 1 - {{v}_{c}}^{2} ) - {E}_{s} ( {v}_{c} + {{v}_{c}}^{2} ) ]\end{matrix}} \qquad ( 2 )$$

in the formula: p_{c1} is the cement sheath-casing interface pressure, MPa; p_{c2} is the cement sheath-formation interface pressure, MPa; Δpᵢ is the increased inner casing pressure when fracturing, MPa; ΔT is the change value of wellbore temperature when fracturing, ° C.; rᵢ is the inner radius of the casing, mm; r₁ is the outer radius of the casing and inner radius of the cement sheath, mm; r₂ is the outer radius of cement sheath and inner radius of the formation, mm; rₒ is the outer radius of the formation, mm; Eₛ, E_{c}, E_{f} are the elastic modulus of the casing, cement sheath and formation, MPa; vₛ, v_{c} and v_{f} are the Poisson's ratios of the casing, cement sheath and formation, respectively, dimensionless. αₛ, α_{c}, and α_{f} are the linear expansion coefficients of the casing, cement sheath, and formation, respectively, 1/° C.

S2, the tangential stress distribution curve σ_{θ}(x) of the crack-free cement sheath when fracturing is obtained;

specifically, based on the thick-walled cylinder theory, calculating the tangential stress distribution of crack-free cement sheath when fracturing by Formula (3).

$${σ}_{θ} ( x ) = \frac{{p}_{c 1} {r}_{1}^{2}}{{r}_{2}^{2} - {r}_{1}^{2}} [ 1 + \frac{{r}_{2}^{2}}{{( {r}_{1} + x )}^{2}} ] - \frac{{p}_{c 2} {r}_{2}^{2}}{{r}_{2}^{2} - {r}_{1}^{2}} [ 1 + \frac{{r}_{1}^{2}}{{( {r}_{1} + x )}^{2}} ] \qquad ( 3 )$$

$$( 0 \leq x \leq {r}_{2} - {r}_{1} )$$

in the formula: σ_{θ} is a tangential stress of the crack-free cement sheath when fracturing, MPa.

S3, based on the maximum tensile stress criterion to determine whether the radial initial cracking of the cement sheath occurs when fracturing and calculate the initial cracking length a;

specifically, t and σ_{ct} are obtained, and the curves of σ_{θ} and σ_{ct} are drawn in the σ(x) coordinate system. Based on the maximum tensile stress criterion, whether the radial initial cracking occurs in the cement sheath when fracturing is judged, and the radial initial cracking length a of the cement sheath is obtained by Formula (4)

$$a = \{ \begin{matrix}0 , & {σ}_{θ} ( x ) < {σ}_{ct} & No radial initial cracking in cement sheath \\ {r}_{b} - {r}_{1} , & {σ}_{θ} ( {r}_{b} ) = {σ}_{ct} & Radial initial cracking in a part of cement sheath \\ t , & {σ}_{θ} ( x ) > {σ}_{ct} & Radial initial cracking penetrates in cement sheath\end{matrix} \qquad ( 4 )$$

in the formula: a is the radial initial cracking length of the cement sheath, mm; t is the thickness of the cement sheath, mm; σ_{ct} is the tensile strength of the cement sheath, MPa; r_{b} is the abscissa corresponding to the intersection of σ_{θ} and σ_{ct} curves, mm.

S4, when 0<a<t, calculating the stress intensity factor K_{I} (a) of the tip of the radial initial cracking of the cement sheath when fracturing based on the weight function method;

specifically, when it is judged whether 0<a<t is satisfied, if it is satisfied, Formulas (5)-(17) is used to calculate the stress intensity factor K_{I} (a) of the tip of the radial initial cracking of the cement sheath when fracturing

$${K}_{I} ( a ) = \frac{{p}_{c 1} {r}_{1}^{2} - {p}_{c 2} {r}_{2}^{2}}{{r}_{2}^{2} - {r}_{1}^{2}} \frac{1}{\sqrt{2 π} F} \{ 4 F \sqrt{a} + \frac{2}{3} ( 4 \frac{dF}{da} + \frac{2 F}{a} + \frac{3 G}{2 a} ) {a}^{3 / 2} + \frac{2}{5 a} ( \frac{dG}{da} - \frac{G}{2 a} ) {a}^{5 / 2} \} + \frac{{r}_{1}^{2} {r}_{1}^{2} ( {p}_{c 1} - {p}_{c 2} )}{{r}_{2}^{2} - {r}_{1}^{2}} \frac{1}{\sqrt{2 π} F} \{ \begin{matrix}2 F [ \frac{\sqrt{a}}{{r}_{1} ( a + {r}_{1} )} + \frac{1}{2 {( a + {r}_{1} )}^{3 / 2}} ln ( \frac{\sqrt{a + {r}_{1}} + \sqrt{a}}{\sqrt{a + {r}_{1}} - \sqrt{a}} ) ] + \\ ( 4 \frac{dF}{da} + \frac{2 F}{a} + \frac{3 G}{2 a} ) [ \frac{\sqrt{a}}{{r}_{1}} - \frac{1}{2 \sqrt{a + {r}_{1}}} ln ( \frac{\sqrt{a + {r}_{1}} + \sqrt{a}}{\sqrt{a + {r}_{1}} - \sqrt{a}} ) ] + \\ \frac{1}{a} ( \frac{dG}{da} - \frac{G}{2 a} ) [ 3 \sqrt{a} - \frac{3}{2} \sqrt{a + {r}_{1}} ln ( \frac{\sqrt{a + {r}_{1}} + \sqrt{a}}{\sqrt{a + {r}_{1}} - \sqrt{a}} ) + \frac{{a}^{3 / 2}}{{r}_{1}} ]\end{matrix} \} \qquad ( 5 )$$

$$F = {A}_{1} + {A}_{2} {a}^{1 / 2} + {A}_{3} a \qquad ( 6 )$$

$${A}_{1} = \frac{w + 1}{2 \sqrt{π} {w}^{2}} {( w - 1 )}^{1 / 2} \times 5.714 \qquad ( 7 )$$

$${A}_{2} = - \frac{w + 1}{2 \sqrt{π} {w}^{2}} {t}^{- 1 / 2} \times 4.258 \qquad ( 8 )$$

$${A}_{3} = \frac{w + 1}{2 \sqrt{π} {w}^{2} {t ( w - 1 )}^{1 / 2}} \times 5.561 \qquad ( 9 )$$

$$w = {r}_{2} / {r}_{1} \qquad ( 10 )$$

$$G = ( {I}_{1} - 4 {FI}_{2} \sqrt{a} ) \sqrt{a} / {I}_{3} \qquad ( 11 )$$

$${I}_{1} = π \sqrt{2} \{ \frac{1}{2} {A}_{1}^{2} {a}^{2} + \frac{{A}_{2}^{2} + 2 {A}_{1} {A}_{3}}{3} {a}^{3} + \frac{1}{4} {A}_{3}^{2} {a}^{4} + \frac{4}{5} {A}_{1} {A}_{2} {a}^{5 / 2} + \frac{7}{4} {A}_{1} {A}_{3} {a}^{7 / 2} \} \qquad ( 12 )$$

$${I}_{2} = \frac{1}{2} \{ {r}_{1}^{2} [ \frac{\sqrt{a}}{{r}_{1}} - \frac{1}{2 \sqrt{a + {r}_{1}}} ln \frac{\sqrt{a + {r}_{1}} + \sqrt{a}}{\sqrt{a + {r}_{1}} - \sqrt{a}} ] + \frac{2}{3} {a}^{3 / 2} \} \qquad ( 13 )$$

$${I}_{3} = \frac{1}{2} \{ {r}_{1}^{2} [ 3 \sqrt{a} + \frac{a}{{r}_{1}} \sqrt{a} - \frac{3}{2} \sqrt{a + {r}_{1}} ln \frac{\sqrt{a + {r}_{1}} + \sqrt{a}}{\sqrt{a + {r}_{1}} - \sqrt{a}} ] + \frac{2}{5} {a}^{5 / 2} \} \qquad ( 14 )$$

$$\frac{dF}{da} = \frac{1}{2} \sqrt{\frac{{r}_{2} - {r}_{1}}{π}} \frac{{r}_{1} + {r}_{2}}{{r}_{2}^{2}} [ - 2.129 \frac{{r}_{1}}{\sqrt{a} ( {r}_{2} - {r}_{1} )} + 5.651 \frac{{r}_{1}^{3 / 2}}{{( {r}_{2} - {r}_{1} )}^{2}} ] \qquad ( 15 )$$

$$\frac{dG}{da} = \frac{1}{{I}_{3}} \{ \frac{( 2 \sqrt{2} π {F}^{2} {a}^{2} + {I}_{1} )}{2 \sqrt{a}} - 4 a ( \frac{dF}{da} {I}_{2} + F \frac{{dI}_{2}}{da} ) - ( 4 F + \frac{3}{2} G ) {I}_{2} \} \qquad ( 16 )$$

$$\frac{{dI}_{2}}{da} = \frac{1}{2} \{ {r}_{1}^{2} [ \frac{\sqrt{a}}{2 {r}_{1} ( a + {r}_{1} )} + \frac{1}{4 ( a + {r}_{1} ) \sqrt{a + {r}_{1}}} ln \frac{\sqrt{a + {r}_{1}} + \sqrt{a}}{\sqrt{a + {r}_{1}} - \sqrt{a}} ] + \sqrt{a} \} \qquad ( 17 )$$

in the formula, K_{I} is the stress intensity factor of the tip of the initial radial cracking of the cement sheath, N·mm^{-3/2}; A₁, A₂, A₃, F, G, I₁, I₂, I₃ are the intermediate functions.

S5, K_{I}(a) is compared with the fracture toughness K_{Ic} of the cement sheath, if K_{I} (a)≥K_{Ic}, it is judged that the cement sheath will undergo a radial crack propagation and transfixion;

specifically, K_{Ic} is obtained, and K_{I} (a) is compared with the fracture toughness K_{Ic} of the cement sheath, if K_{I} (a)≥K_{Ic}, it is determined that the cement sheath will undergo a radial crack propagation and transfixion.

S6, the cement slurry system is replaced, the tensile strength σ_{ct} and the fracture toughness K_{Ic} of the cement sheath are improved, and S1-S5 are repeated until σ_{θ}(x)<0.9σ_{ct} or K_{I}(a)<0.9K_{Ic} is satisfied.

Specifically, the cement slurry system is replaced to improve the tensile strength σ_{ct} and fracture toughness K_{Ic} of the cement sheath, and S1-S5 are repeated until σ_{θ}(x)<0.9σ_{ct} or K_{I}(a)<0.9K_{Ic} is satisfied.

In the above steps, rᵢ, r₁, r₂, t, rₒ can be obtained by consulting the drilling and completion engineering data, Δpᵢ and ΔT can be calculated by consulting the fracturing construction data, Eₛ, E_{c}, E_{f}, vₛ, v_{c}, v_{f}, αₛ, α_{c}, α_{f}, σ_{ct}, and K_{Ic} can be obtained by experimental measurement or by consulting the parameters of the product.

### Embodiment 1

By consulting the drilling and completion engineering data, the inner radius of the casing rᵢ is 57.15 mm, the outer radius of the casing or the inner radius of the cement sheath r₁ is 69.85 mm, the outer radius of the cement sheath or the inner radius of the formation r₂ is 107.95 mm, the thickness of the cement sheath t is 38.1 mm, and the outer radius of the formation rₒ is 1079.5 mm; by consulting the fracturing construction data, the increased inner casing pressure Δpᵢ when fracturing is 70 MPa, and the wellbore temperature change value ΔT when fracturing is −60° C.; by consulting the product parameters, the elastic modulus Eₛ of the casing is 210 GPa, the Poisson's ratio vₛ of the casing is 0.3, and the linear expansion coefficient as of the casing is 1.2×10⁻⁵1/° C.; the experimental results show that the elastic modulus E_{c} of cement sheath is 10 GPa, the Poisson's ratio v_{c} of cement sheath is 0.23, the linear expansion coefficient & of cement sheath is 0.6×10⁻⁶1/° C., the tensile strength σ_{ct} of cement sheath is 3.6 MPa, the fracture toughness K_{Ic} of cement sheath is 20N·mm^{-3/2}, the elastic modulus E_{f} of surrounding rock is 21 GPa, the Poisson's ratio v_{f} of surrounding rock is 0.20, and the linear expansion coefficient α_{f} of surrounding rock is 0.5×10−61/° C.

Step 1, the pressure p_{c1} on the cement sheath-casing interface and the pressure p_{c2} on the cement sheath-formation interface when fracturing are calculated to be 5.79 MPa and 2.71 MPa respectively by using Formulas (1) to (2).

Step 2, Formula (3) is used to calculate and obtain the tangential stress distribution curve σ_{θ}(x) of the crack-free cement sheath when fracturing (FIG. 1).

Step 3, the σ_{θ} and σ_{ct} curves are drawn in the σ(x) coordinate system, based on the maximum tensile stress criterion, it is judged that the radial initial cracking of the cement sheath will occur when fracturing, the radial initial cracking length a of the cement sheath is obtained by Formula (4) to be 9.57 mm. (FIG. 2)

Step 4, since 0<a<t, the stress intensity factor K_{I} (a) of the tip of the radial initial cracking of the cement sheath when fracturing is calculated to be 40.01 N·mm_{-3/2} by using Formulas (5) to (17).

Step 5, K_{I} (a) is compared with the fracture toughness K_{Ic} of the cement sheath, K_{I}(a)=40.01N·mm^{-3/2}≥K_{Ic}=20N·mm^{-3/2}, it is determined that the cement sheath will undergo radial crack propagation and transfixion.

Step 6, the tensile strength Out of the cement sheath is increased to 4.2 MPa, and the fracture toughness K_{Ic} of the cement sheath is increased to 25N·mm^{-3/2}, and then S1-S5 is repeated as follows:

Repeating Step 1: the pressure p_{c1} on the cement sheath-casing interface and the pressure p_{c2} on the cement sheath-formation interface when fracturing are calculated to be 5.64 MPa and 2.68 MPa respectively by using Formulas (1) to (2).

Repeating Step 2: Formula (3) is used to calculate and obtain the tangential stress distribution curve σ_{θ}(x) of the crack-free cement sheath when fracturing (FIG. 3)

Repeating Step 3: the σ_{θ} and σ_{ct} curves are drawn in the σ(x) coordinate system, based on the maximum tensile stress criterion, it is judged that the radial initial cracking of the cement sheath will occur when fracturing, the radial initial cracking length a of the cement sheath is obtained by Formula (4) to be 2.55 mm (FIG. 4).

Step 4, since 0<a<t, the stress intensity factor K_{I} (a) of the tip of the radial initial cracking of the cement sheath when fracturing is calculated to be 8.23N·mm^{-3/2} by using Formulas (5) to (17).

Step 5: K_{I} (a) is compared with the fracture toughness K_{Ic} of the cement sheath, K_{I}(a)=8.23N·mm^{-3/2}<0.9K_{Ic}=22.5N·mm^{-3/2}, it is determined that the cement sheath will not undergo a radial crack propagation and transfixion.

Based on the thermo-solid coupling theoretical model of casing-cement sheath-formation combination and the thick-walled cylinder theory, the tangential stress distribution of crack-free cement sheath when fracturing is obtained, the maximum tensile stress criterion is used to judge whether the radial initial cracking of cement sheath occurs when fracturing and calculate the initial cracking length; based on the weight function method, the stress intensity factor of the tip of the radial initial cracking of the cement sheath when fracturing is calculated, the fracture mechanics criterion is used to judge whether the radial crack propagation and transfixion will occur in the cement sheath, the performance parameters of the cement sheath are controlled by the double standards of preventing the radial cracking of the cement sheath and controlling the crack propagation, the risk of radial cracking and crack propagation and transfixion of cement sheath in fracturing wells is rapidly evaluated and an effective control method is proposed. Compared with the existing theoretical method, finite element method, and indoor experimental method to evaluate the risk of radial cracking of cement sheath, this method can quickly evaluate the risk of radial cracking and crack propagation and transfixion of cement sheath in fracturing wellbore and provide an effective control method with high reliability.

The above disclosure is only one or more of the better embodiments of this application, which cannot be used to limit the scope of the rights of this application. The general technical personnel in this field can understand all or part of the process of realizing the above embodiment, and the equivalent changes made according to the claims of this application are still within the scope of this application.

1. A risk evaluation and control method for radial cracking and crack propagation and transfixion of a cement sheath in fracturing wells, comprising the following steps:
S1, obtaining a pressure p_{c1} on a cement sheath-casing interface and a pressure p_{c2} on a cement sheath-formation interface when fracturing, comprising:
based on continuity conditions of a radial displacement of the cement sheath-casing interface and the cement sheath-formation interface, establishing a theoretical model of thermo-solid coupling of casing-cement sheath-formation combination, and calculating the pressure p_{c1} on the cement sheath-casing interface and the pressure p_{c2} on the cement sheath-formation interface when fracturing by Formulas 1-2;
$${p}_{c 1} = \frac{\begin{matrix}[ {α}_{c} {E}_{c} {E}_{s} Δ T ( 1 + {v}_{c} ) - {α}_{s} {E}_{s} {E}_{c} Δ T ( 1 + {v}_{s} ) - \frac{2 {r}_{i}^{2}}{{r}_{1}^{2} - {r}_{i}^{2}} {E}_{c} ( 1 - {{v}_{s}}^{2} ) Δ {p}_{i} ] \times \\ [ {E}_{f} ( {v}_{c} + {{v}_{c}}^{2} ) - \frac{{r}_{2}^{2} + {r}_{1}^{2}}{{r}_{2}^{2} - {r}_{1}^{2}} {E}_{f} ( 1 - {{v}_{c}}^{2} ) - \frac{{r}_{o}^{2} + {r}_{2}^{2}}{{r}_{o}^{2} - {r}_{2}^{2}} {E}_{c} ( 1 - {{v}_{f}}^{2} ) - {E}_{c} ( {v}_{f} + {{v}_{f}}^{2} ) ] - \\ [ {α}_{f} {E}_{f} {E}_{c} Δ T ( 1 + {v}_{f} ) - {α}_{c} {E}_{c} {E}_{f} Δ T ( 1 + {v}_{c} ) ] \times [ \frac{2 {r}_{2}^{2}}{{r}_{2}^{2} - {r}_{1}^{2}} {E}_{s} ( 1 - {{v}_{c}}^{2} ) ]\end{matrix}}{\begin{matrix}[ {E}_{c} ( {v}_{s} + {{v}_{s}}^{2} ) - \frac{{r}_{1}^{2} + {r}_{i}^{2}}{{r}_{1}^{2} - {r}_{i}^{2}} {E}_{c} ( 1 - {{v}_{s}}^{2} ) - \frac{{r}_{2}^{2} + {r}_{1}^{2}}{{r}_{2}^{2} - {r}_{1}^{2}} {E}_{s} ( 1 - {{v}_{c}}^{2} ) - {E}_{s} ( {v}_{c} + {{v}_{c}}^{2} ) ] \times \\ [ {E}_{f} ( {v}_{c} + {{v}_{c}}^{2} ) - \frac{{r}_{2}^{2} + {r}_{1}^{2}}{{r}_{2}^{2} - {r}_{1}^{2}} {E}_{f} ( 1 - {{v}_{c}}^{2} ) - \frac{{r}_{o}^{2} + {r}_{2}^{2}}{{r}_{o}^{2} - {r}_{2}^{2}} {E}_{c} ( 1 - {{v}_{f}}^{2} ) - {E}_{c} ( {v}_{f} + {{v}_{f}}^{2} ) ] - \\ [ \frac{2 {r}_{1}^{2}}{{r}_{2}^{2} - {r}_{1}^{2}} {E}_{f} ( 1 - {{v}_{c}}^{2} ) ] \times [ \frac{2 {r}_{2}^{2}}{{r}_{2}^{2} - {r}_{1}^{2}} {E}_{s} ( 1 - {{v}_{c}}^{2} ) ]\end{matrix}} \qquad 1$$
$${p}_{c 2} = \frac{\begin{matrix}[ {α}_{c} {E}_{c} {E}_{s} Δ T ( 1 + {v}_{c} ) - {α}_{s} {E}_{s} {E}_{c} Δ T ( 1 + {v}_{s} ) - \\ \frac{2 {r}_{i}^{2}}{{r}_{1}^{2} - {r}_{i}^{2}} {E}_{c} ( 1 - {{v}_{s}}^{2} ) Δ {p}_{i} ] \times [ \frac{2 {r}_{1}^{2}}{{r}_{2}^{2} - {r}_{1}^{2}} {E}_{f} ( 1 - {v}_{c}^{2} ) ] - \\ [ {α}_{f} {E}_{f} {E}_{c} Δ T ( 1 + {v}_{f} ) - {α}_{c} {E}_{c} {E}_{f} Δ T ( 1 + {v}_{c} ) ] \times [ \begin{matrix}{E}_{c} ( {v}_{s} + {{v}_{s}}^{2} ) - \frac{{r}_{1}^{2} + {r}_{i}^{2}}{{r}_{1}^{2} - {r}_{i}^{2}} {E}_{c} ( 1 - {{v}_{s}}^{2} ) - \\ \frac{{r}_{2}^{2} + {r}_{1}^{2}}{{r}_{2}^{2} - {r}_{1}^{2}} {E}_{s} ( 1 - {{v}_{c}}^{2} ) - {E}_{s} ( {v}_{c} + {{v}_{c}}^{2} )\end{matrix} ]\end{matrix}}{\begin{matrix}[ \frac{2 {r}_{2}^{2}}{{r}_{2}^{2} - {r}_{1}^{2}} {E}_{s} ( 1 - {{v}_{c}}^{2} ) ] \times [ \frac{2 {r}_{1}^{2}}{{r}_{2}^{2} - {r}_{1}^{2}} {E}_{f} ( 1 - {{v}_{c}}^{2} ) ] - \\ [ {E}_{f} ( {v}_{c} + {{v}_{c}}^{2} ) - \frac{{r}_{2}^{2} + {r}_{1}^{2}}{{r}_{2}^{2} - {r}_{1}^{2}} {E}_{f} ( 1 - {{v}_{c}}^{2} ) - \frac{{r}_{o}^{2} + {r}_{2}^{2}}{{r}_{o}^{2} - {r}_{2}^{2}} {E}_{c} ( 1 - {{v}_{f}}^{2} ) - {E}_{c} ( {v}_{f} + {{v}_{f}}^{2} ) ] \times \\ [ {E}_{c} ( {v}_{s} + {{v}_{s}}^{2} ) - \frac{{r}_{1}^{2} + {r}_{i}^{2}}{{r}_{1}^{2} - {r}_{i}^{2}} {E}_{c} ( 1 - {{v}_{s}}^{2} ) - \frac{{r}_{2}^{2} + {r}_{1}^{2}}{{r}_{2}^{2} - {r}_{1}^{2}} {E}_{s} ( 1 - {{v}_{c}}^{2} ) - {E}_{s} ( {v}_{c} + {{v}_{c}}^{2} ) ]\end{matrix}} \qquad 2$$
in the formula: p_{c1} is a cement sheath-casing interface pressure, MPa; p_{c2} is a cement sheath-formation interface pressure, MPa; Δpᵢ is an increased inner casing pressure when fracturing, MPa; ΔT is a change value of wellbore temperature when fracturing, ° C.; rᵢ is an inner radius of a casing, mm; r₁ is an outer radius of the casing and an inner radius of the cement sheath, mm; r₂ is an outer radius of the cement sheath and an inner radius of a formation, mm; rₒ is an outer radius of the formation, mm; Eₛ, E_{c}, E_{f} are elastic modulus of the casing, the cement sheath and the formation, respectively, MPa; vₛ, v_{c} and v_{f} are Poisson's ratios of the casing, the cement sheath and the formation, respectively, dimensionless; αₛ, α_{c}, and α_{f} are linear expansion coefficients of the casing, the cement sheath, and the formation, respectively, 1/° C.;
S2, obtaining a tangential stress distribution curve σ_{θ}(x) of a crack-free cement sheath when fracturing;
S3, judging whether a radial initial cracking of the cement sheath occurs when fracturing based on a maximum tensile stress criterion and calculating an initial cracking length a;
S4, when 0<a<t, calculating a stress intensity factor K_{I} (a) of a tip of the radial initial cracking of the cement sheath when fracturing based on a weight function method, comprising:
using Formulas 5-17 to calculate the stress intensity factor K_{I} (a) of the tip of the radial initial cracking of the cement sheath when fracturing;
$${K}_{I} ( a ) = \frac{{p}_{c 1} {r}_{1}^{2} - {p}_{c 2} {r}_{2}^{2}}{{r}_{2}^{2} - {r}_{1}^{2}} \frac{1}{\sqrt{2 π} F} \{ 4 F \sqrt{a} + \frac{2}{3} ( 4 \frac{dF}{da} + \frac{2 F}{a} + \frac{3 G}{2 a} ) {a}^{3 / 2} + \frac{2}{5 a} ( \frac{dG}{da} - \frac{G}{2 a} ) {a}^{5 / 2} \} + \frac{{r}_{1}^{2} {r}_{1}^{2} ( {p}_{c 1} - {p}_{c 2} )}{{r}_{2}^{2} - {r}_{1}^{2}} \frac{1}{\sqrt{2 π} F} \{ \begin{matrix}2 F [ \frac{\sqrt{a}}{{r}_{1} ( a + {r}_{1} )} + \frac{1}{2 {( a + {r}_{1} )}^{3 / 2}} ln ( \frac{\sqrt{a + {r}_{1}} + \sqrt{a}}{\sqrt{a + {r}_{1}} - \sqrt{a}} ) ] + \\ ( 4 \frac{dF}{da} + \frac{2 F}{a} + \frac{3 G}{2 a} ) [ \frac{\sqrt{a}}{{r}_{1}} - \frac{1}{2 \sqrt{a + {r}_{1}}} ln ( \frac{\sqrt{a + {r}_{1}} + \sqrt{a}}{\sqrt{a + {r}_{1}} - \sqrt{a}} ) ] + \\ \frac{1}{a} ( \frac{dG}{da} - \frac{G}{2 a} ) [ 3 \sqrt{a} - \frac{3}{2} \sqrt{a + {r}_{1}} ln ( \frac{\sqrt{a + {r}_{1}} + \sqrt{a}}{\sqrt{a + {r}_{1}} - \sqrt{a}} ) + \frac{{a}^{3 / 2}}{{r}_{1}} ]\end{matrix} \} \qquad 5$$
$$F = {A}_{1} + {A}_{2} {a}^{1 / 2} + {A}_{3} a \qquad 6$$
$${A}_{1} = \frac{w + 1}{2 \sqrt{π} {w}^{2}} {( w - 1 )}^{1 / 2} \times 5.714 \qquad 7$$
$${A}_{2} = - \frac{w + 1}{2 \sqrt{π} {w}^{2}} {t}^{- 1 / 2} \times 4.258 \qquad 8$$
$${A}_{3} = \frac{w + 1}{2 \sqrt{π} {w}^{2} {t ( w - 1 )}^{1 / 2}} \times 5.561 \qquad 9$$
$$w = {r}_{2} / {r}_{1} \qquad 10$$
$$G = ( {I}_{1} - 4 {FI}_{2} \sqrt{a} ) \sqrt{a} / {I}_{3} \qquad 11$$
$${I}_{1} = π \sqrt{2} \{ \frac{1}{2} {A}_{1}^{2} {a}^{2} + \frac{{A}_{2}^{2} + 2 {A}_{1} {A}_{3}}{3} {a}^{3} + \frac{1}{4} {A}_{3}^{2} {a}^{4} + \frac{4}{5} {A}_{1} {A}_{2} {a}^{5 / 2} + \frac{7}{4} {A}_{1} {A}_{3} {a}^{7 / 2} \} \qquad 12$$
$${I}_{2} = \frac{1}{2} \{ {r}_{1}^{2} [ \frac{\sqrt{a}}{{r}_{1}} - \frac{1}{2 \sqrt{a + {r}_{1}}} ln \frac{\sqrt{a + {r}_{1}} + \sqrt{a}}{\sqrt{a + {r}_{1}} - \sqrt{a}} ] + \frac{2}{3} {a}^{3 / 2} \} \qquad 13$$
$${I}_{3} = \frac{1}{2} \{ {r}_{1}^{2} [ 3 \sqrt{a} + \frac{a}{{r}_{1}} \sqrt{a} - \frac{3}{2} \sqrt{a + {r}_{1}} ln \frac{\sqrt{a + {r}_{1}} + \sqrt{a}}{\sqrt{a + {r}_{1}} - \sqrt{a}} ] + \frac{2}{5} {a}^{5 / 2} \} \qquad 14$$
$$\frac{dF}{da} = \frac{1}{2} \sqrt{\frac{{r}_{2} - {r}_{1}}{π}} \frac{{r}_{1} + {r}_{2}}{{r}_{2}^{2}} [ - 2.129 \frac{{r}_{1}}{\sqrt{a} ( {r}_{2} - {r}_{1} )} + 5.651 \frac{{r}_{1}^{3 / 2}}{{( {r}_{2} - {r}_{1} )}^{2}} ] \qquad 15$$
$$\frac{dG}{da} = \frac{1}{{I}_{3}} \{ \frac{( 2 \sqrt{2} π {F}^{2} {a}^{2} + {I}_{1} )}{2 \sqrt{a}} - 4 a ( \frac{dF}{da} {I}_{2} + F \frac{{dI}_{2}}{da} ) - ( 4 F + \frac{3}{2} G ) {I}_{2} \} \qquad 16$$
$$\frac{{dI}_{2}}{da} = \frac{1}{2} \{ {r}_{1}^{2} [ \frac{\sqrt{a}}{2 {r}_{1} ( a + {r}_{1} )} + \frac{1}{4 ( a + {r}_{1} ) \sqrt{a + {r}_{1}}} ln \frac{\sqrt{a + {r}_{1}} + \sqrt{a}}{\sqrt{a + {r}_{1}} - \sqrt{a}} ] + \sqrt{a} \} \qquad 17$$
in the formula, K_{I} is the stress intensity factor of the tip of the initial radial cracking of the cement sheath, N·mm^{-3/2}; A₁, A₂, A₃, F, G, I₁, I₂, I₃ are intermediate functions;
S5, comparing K_{I} (a) with a fracture toughness K_{Ic} of the cement sheath, and when K_{I}(a)≥K_{Ic}, judging that the cement sheath will undergo a radial crack propagation and transfixion;
S6, replacing a cement slurry system, improving a tensile strength σ_{ct} and the fracture toughness K_{Ic} of the cement sheath, and repeating S1-S5 with an improved tensile strength σ_{ct} and an improved fracture toughness K_{Ic} of the cement sheath until σ_{θ}(x)<0.90σ_{ct} or K_{I}(a)<0.9K_{Ic} is satisfied.

2. The risk evaluation and control method for radial cracking and crack propagation and transfixion of the cement sheath in the fracturing wells according to claim 1, wherein the step of obtaining the tangential stress distribution curve σ_{θ}(x) of the crack-free cement sheath when fracturing further comprises:
based on a thick-walled cylinder theory, calculating the tangential stress distribution of the crack-free cement sheath when fracturing by Formula 3:
$${σ}_{θ} ( x ) = \frac{{p}_{c 1} {r}_{1}^{2}}{{r}_{2}^{2} - {r}_{1}^{2}} [ 1 + \frac{{r}_{2}^{2}}{{( {r}_{1} + x )}^{2}} ] - \frac{{p}_{c 2} {r}_{2}^{2}}{{r}_{2}^{2} - {r}_{1}^{2}} [ 1 + \frac{{r}_{1}^{2}}{{( {r}_{1} + x )}^{2}} ] \qquad 3$$
$$( 0 \leq x \leq {r}_{2} - {r}_{1} )$$
in the formula: σ_{θ} is a tangential stress of the crack-free cement sheath when fracturing, MPa.

3. The risk evaluation and control method for radial cracking and crack propagation and transfixion of the cement sheath in the fracturing wells according to claim 2, wherein the step of judging whether the radial initial cracking of the cement sheath occurs when fracturing based on the maximum tensile stress criterion and calculating the initial cracking length a further comprises:
drawing curves of σ_{θ} and σ_{ct} in a σ(x) coordinate system, and obtaining the radial initial cracking length a of the cement sheath by Formula 4:
$$a = \{ \begin{matrix}0 , & {σ}_{θ} ( x ) < {σ}_{ct} & No radial initial cracking in \\ cement sheath \\ {r}_{b} - {r}_{1} , & {σ}_{θ} ( {r}_{b} ) = {σ}_{ct} & Radial initial cracking in a part \\ of cement sheath \\ t , & {σ}_{θ} ( x ) > {σ}_{ct} & Radial initial cracking penetrates \\ in cement sheath\end{matrix}$$
in the formula: a is the radial initial cracking length of the cement sheath, mm; t is a thickness of the cement sheath, mm; σ_{ct} is a tensile strength of the cement sheath, MPa; r_{b} is an abscissa corresponding to an intersection of σ_{θ} and σ_{ct} curves, mm.
